(19) United States
(12) Patent Application Publication
(10) Pub. No.: US 2017/0232468 A1
(43) Pub. Date: Aug. 17, 2017

(54) REMOVABLE AND RE-USABLE PAINTERS EDGE USEFUL FOR PAINT AND CAULKING

(71) Applicant: John H. Tepe, Coolidge, AZ (US)

(72) Inventor: John H. Tepe, Coolidge, AZ (US)

(21) Appl. No.: 15/430,337

(22) Filed: Feb. 10, 2017

Related U.S. Application Data
(60) Provisional application No. 62/293,705, filed on Feb. 10, 2016.

(51) Int. Cl. B05C 21/00

(52) U.S. Cl. CPC B05C 21/005

(57) ABSTRACT

The embodied invention is a removable masking article comprising a thin board made from paper or cover stock (40# basis weight or more) in the dimensions of 17×2¾ or 11×17 inches. One side incorporates a tacky, removable adhesive that starts at one of the long edges and covers approximately one inch of the surface area. The low tack adhesive allows the product to be applied multiple times, provided the surface is free of moisture and dirt. The low tack adhesive does not leave a residue when removed from a surface. It is economically made by using a standard size 11×17″ paper or cardboard in whole or in cut pieces.

### CROSS REFERENCE TO RELATED APPLICATIONS

This application claims the benefit of U.S. provisional application 62/293,705 filed on Feb. 10, 2016. The provisional application is incorporated by reference herein.

### STATEMENT REGARDING FEDERALLY SPONSORED RESEARCH OR DEVELOPMENT

Not applicable.

### REFERENCE TO SEQUENCE LISTING, A TABLE, OR COMPUTER PROGRAM LISTING

Not applicable.

### BACKGROUND OF THE INVENTION

(1) Field of the Invention

This invention is directed toward reusable and convenient painting materials that protects a surface during painting. In particular, this invention is directed toward creating a well-defined edge during application of paint to a surface such as a wall or the application of caulking such as a window pane.

(2) Description of Related Art

Painters use a masking device, such as a plastic board or metal strip, to block off areas that are not to be painted. These devices often include handles and other convenience features and are designed to ensure that paint is only applied to the surface that the painter want to be painted.

Unfortunately, it is often the case that a paint laden paintbrush will leave significant amounts of paint on the edge of these devices. The paint is then liable to wrap around the edge and be applied on the surface that is masked off. If the painter reduces the amount of paint in the paintbrush to prevent undesirable wrap around, the painter may have to repeat the application a second or third time to get sufficient coverage.

A common way to protect a surface during painting is to utilize a painter's tape. The thin and flexible masking tape is very common but it is problematic. It is difficult to apply it correctly to get the edge evenly applied in the desired spot. Also, it is difficult to lay down painter's tape and make a true straight line. Minor masking gaps allow paint to be applied to the masked surface causing unsightly paint lines to remain. Corners or oddly angled surfaces that need to be masked cause similar problems.

The thin-ness of the painter's tape is an additional problem. To provide flexibility, the tape must necessarily be thin. The end result is that a painter has to frequently dig, cut and pick off parts of the painter's tape in a clean-up effort. Additionally, the narrowness of painter's tape makes it too flexible and hard to handle. The tape often folds over and sticks back onto itself. However, when paint has dried, pulling the tape off a surface can cause the tape to tear as solidified paint bonding to the unmasked surface will be stronger than the tape's shear stress.

Another problem with painter's tape is that it is designed for a one-time use. It is not economical or eco-friendly to dispose of the tape after each use.

Another problem with painter's tape is that the adhesive completely covers one side of the tape. This causes painter frustration with removal as the tape will stick well to a variety of surfaces, at times with a stronger adhesion bond than the shear stress of the tape. This will result in tearing of the tape rather than peeling it off of a surface.

There is a need in the market place for an improved masking method/article that will balance the conflicting objectives of tacky bonding, ease of application, peeling, withdrawal without leaving paint marks, and its application in a simple manner. Additionally, it must also be affordable compared with other masking methods to be truly useful.

### BRIEF SUMMARY OF THE INVENTION

The embodied invention is a removable masking article comprising a thin board made from paper or card stock (such as a 40 lb basis weight or more) in the dimensions of 17×2¾ or 11×17 inches. The painter's edge is made from a flexible backing, such as card stock, and utilizes a tacky, peelable adhesive on one of the two sides, along one of the long edges. The low tack adhesive allows the product to be applied multiple times, provided that the surface is free of moisture and dirt. The low tack adhesive does not leave a residue when removed from a surface. It is economically made by using a standard size 11×17″ paper or cardboard in whole or cut into pieces.

### BRIEF DESCRIPTION OF THE SEVERAL VIEWS OF THE DRAWING(S)

FIG. 1 is a package of the embodied invention where 50 painter's edge sheets are packaged.

FIG. 2A is a top view the painter's edge.

FIG. 2B is a bottom view of the painter's edge showing where the adhesive is applied.

### DETAILED DESCRIPTION OF THE INVENTION

Cleaner, Straighter, Easier Surface Masking.

The embodied invention is a two sided, generally rectangular shape, painters edge that provides for masking off a surface with a straight edge that defines where the paint will end. The painter's edge is made from a flexible backing, such as card stock, and utilizes a tacky, peelable adhesive on one of the two sides, along one of the long edges.

To use the embodied invention, a painter puts down the rectangular painter's edge exactly where the painter wants it to be. Typically, this might be on baseboards at the bottom of a wall, at the wall to ceiling edge, or around window frames and door frames. The painters edge is put down as a paint mask and protects a surface from receiving paint. The adhesive side is only moderately adhered to the masked surface, and is readily peelable when the painting is completed. To remove it, simply lift it off the masked surface and stack it up to be re-used. The adhesive is chosen so that it firmly bonds to the card stock, but only peelably bonds to the masked surface. This is an important balance point of adhesion to ensure that the peelable nature of the painter's edge will not leave any adhesive residue when removed.

The painter always has the option of cutting (or tearing) the painters edge to address a particular masking geometry. Cutouts, angles, and corners are readily covered by adaptive use of the painter's edge. For example, a curved edge is addressed by using the painters edge as line segments (cords) of a circle. The painters edge is preferably overlapped when in use to avoid masking gaps that allow paint to penetrate.

The painter's edge is preferably packaged in a way to take up a smaller shelf space in a store. To that end, the packaging preferably utilizes a clear wrapping that shows off purchasing information to the consumer without the need to add other signs on the store shelf. The product information can include product bar codes, total number, total length, pricing, etc.

One embodiment of the invention is a rectangular dimension of 2¾″ high by 17″ wide. This provides for an efficient use of paper and also accommodates a variety of hand and automatic painting equipment. The cardstock used to manufacture the painter's edge can be taken from a standard 11″×17″ cardboard stock. Four painter's edge pieces can be cut from it. Another embodiment is to utilize a large 11″×17″ so as to control paint splatter. This is beneficial in some situations such as when painting with a roller.

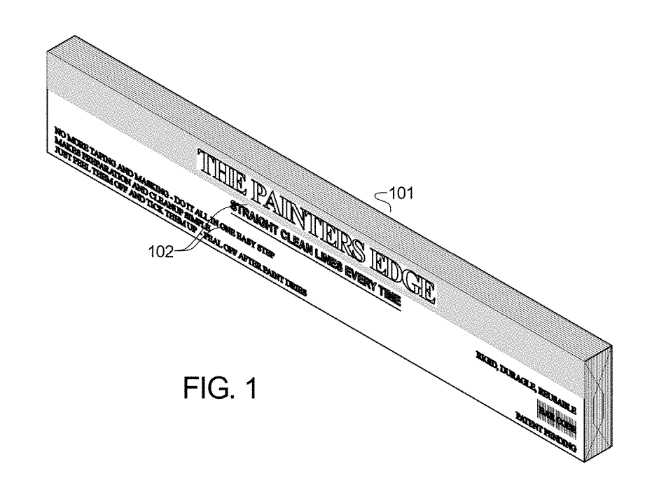

FIG. 1 shows a package of painter's edges 101 with suitable product information 102 on display.

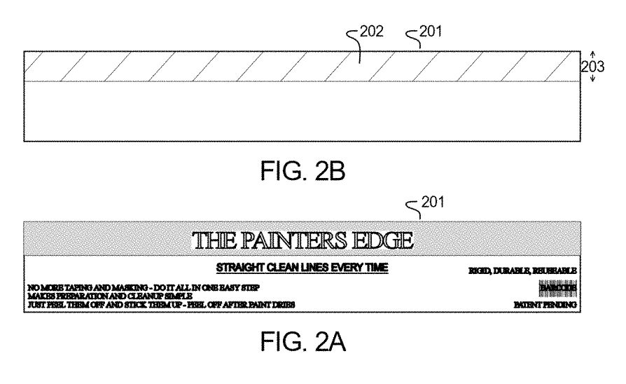

FIG. 2A is a top view the painter's edge 201 which is blank/unprinted in one embodiment. Alternately, instructions and other images can also be applied to the top surface shown, including the product labeling previously described in FIG. 1. FIG. 2B is a bottom view of the painter's edge 201 showing where the tacky adhesive 202 is applied. It is highly preferable that the adhesive is continuous along the length of the painter's edge creating a bondable surface that will be applied to a surface to be masked. The height of the adhesive 203 is measured from the masking edge, that is, the top edge as it is shown.

Advantages of the painter's edge include making surface preparation easier and less time consuming. The painters edge is also highly intuitive in use and little instruction is needed for a painter to understand how to use it properly.

Current advantages of the painter's edge over other masking products currently in the marketplace include:
1) The painter's edge incorporates adhesive and masking in a single product.
2) The painter's edge is stiff and makes it easier to mask a long edge.
3) Eliminate painter's tape or any other tape based masking.
4) The painters edge makes a true straight edge every time.
5) The painter's edge simplifies and reduces clean up time by eliminating sticky balls of masking tape.
6) The improved width of the painter's edge reduces splattering on the masked surface.
7) The painter's edge is re-usable by peeling of and re-applying to a new surface.

In a preferred embodiment, the flexible backing for the painter's edge is made from a durable card stock, at least a 40# basis weight and thicker.

It should be emphasized that the painter's edge is re-useable. It is readily pulled off the masked surface and applied again to another surface. A non-toxic pressure sensitive adhesive is used.

The painters edge is readily made from recycled paper or cardboard as any minor backing imperfections are of little concern.

The painters edge can be folded if desired by the painter. Some situations, such as going around a corner, may be better covered if the edge is folded to match the surface curvature.

The painters edge can also be used in decorative applications as a stencil, such as creating circles or other decorative wall images. An image can be cut out of the painter's edge. It can also be used in presentations and promotional uses where the advertisement or information to be presented is temporary.

While various embodiments of the present invention have been described, the invention may be modified and adapted to various operational methods to those skilled in the art. Therefore, this invention is not limited to the description and figure shown herein, and includes all such embodiments, changes, and modifications that are encompassed by the scope of the claims.

I claim:

1. A re-usable painter's masking edge comprising:
A) a thin flexible backing with two sides and four edges, wherein said thin flexible backing comprises:
a. a first elongated edge,
b. a second elongated edge substantially the same length as said first elongated edge,
c. a third short edge, and
d. a fourth short edge substantially the same length as said third short edge,
B) a pressure sensitive adhesive applied along said first elongated edge,
C) wherein said pressure sensitive adhesive is applied only partly to one of said two sides,
D) wherein said flexible backing is removable when applied to a surface, and
E) wherein said pressure sensitive adhesive does not leave a residue when said flexible backing is removed from said surface.

2. The re-useable painter's masking edge according to claim 1 wherein said re-useable painter's masking edge is sold in wrapped packages.

3. The re-useable painter's masking edge according to claim 1 wherein said first elongated edge is 17 inches long and said third short edge is 2¾″ long.

4. The re-useable painter's masking edge according to claim 1 wherein said flexible backing is at least 40 lb. basis weight and is made from either paper or card stock.

5. The re-useable painter's masking edge according to claim 1 wherein said first elongated edge is 17 inches long and said third short edge is 11″ long.

6. The re-useable painter's masking edge according to claim 1 wherein said pressure sensitive adhesive is bonded to said flexible backing and is applied by pressing said pressure sensitive adhesive against said surface.

7. The re-useable painter's masking edge according to claim 1 wherein said pressure sensitive adhesive provides for said flexible backing to be removable for re-use.
